(19) United States
(12) Patent Application Publication
(10) Pub. No.: US 2025/0379515 A1
(43) Pub. Date: Dec. 11, 2025

(54) SYSTEM FOR AN ON-BOARD ELECTRICAL SYSTEM OF A VEHICLE

(71) Applicant: AUDI AG, Ingolstadt (DE)

(72) Inventors: Philipp EBERHART, Ingolstadt (DE); Oliver SELLKE, Wettstetten (DE); Ulrich SINGLE, Ingolstadt (DE)

(21) Appl. No.: 19/229,954

(22) Filed: Jun. 5, 2025

(30) Foreign Application Priority Data
Jun. 6, 2024 (DE) 102024115753.4

(51) Int. Cl. H02M 1/44; B60L 50/51; H02M 7/00

(52) U.S. Cl. CPC H02M 1/44; B60L 50/51; H02M 7/003; B60L 2210/42

(57) ABSTRACT

The disclosure relates to a system for an on-board electrical system of a vehicle, wherein the on-board electrical system has an inverter and a battery. The system has at least one primary shielded external electrical connection and an electromagnetic compatibility (EMC) filter device, wherein the EMC filter device is connected to the inverter via the at least one primary shielded external electrical connection and, wherein the EMC filter device is connected to the battery via at least one secondary external electrical connection.

### BACKGROUND

### Technical Field

The disclosure relates to a system for an on-board electrical system of a vehicle and a method for providing an on-board electrical system.

### Description of the Related Art

An inverter for an electric compressor is known from publication KR20140033584A.

A battery system for a vehicle is known from document WO2021/018398A1.

Publication DE102021118756A1 describes a high-voltage component for a high-voltage on-board electrical system of an electrically powered motor vehicle.

### BRIEF SUMMARY

Against this background, embodiments of the present disclosure provide suitable shielding for an on-board electrical system of a vehicle.

The system according to the disclosure is provided for a, usually electrical, on-board electrical system of a vehicle, e.g., a motor vehicle, wherein the on-board electrical system has, as components, at least one inverter and one battery, which are or are to be connected to one another within the on-board electrical system, to the on-board electrical system and/or as components of the on-board electrical system, for exchanging electrical energy and for transporting electrical energy. The system has, as components, at least one primary shielded external electrical connection and one electromagnetic compatibility (EMC) filter device as supplements for the on-board electrical system. In this case, the EMC filter device is, can be or must be connected, on the one hand, to the inverter via at least one primary, usually electromagnetic, shielded external connection, and, on the other hand, to the battery via at least one secondary external connection. The at least one secondary external electrical connection can also be designed as a component of the presented system.

The EMC filter device for providing electromagnetic compatibility is usually designed to suppress electrical and/or electromagnetic effects. For example, it is designed to filter, attenuate, and/or suppress mutually coupled and common-mode electromagnetic radiation as a possible effect. Alternatively or additionally, it is designed to filter and/or suppress differential-mode and common-mode electromagnetic interference as effects. Furthermore, alternatively or additionally, it is designed to filter, attenuate, and/or suppress differential-mode and common-mode currents.

The EMC filter device or a housing of the EMC filter device has at least one electromagnetic shield.

Furthermore, a shield is provided for the at least one primary external connection, by which or by way of which it is electrically and/or electromagnetically shielded. In a further configuration, the shield of the at least one primary external connection between the inverter and the EMC filter device is or will be also applied to the EMC filter device or its housing and/or is extended to the EMC filter device or its housing. The at least one external connection can be designed as a cable.

To provide electromagnetic compatibility, the EMC filter device has a common-mode filter stage and a differential-mode filter stage. Both of these stages mentioned are connected in series within the housing, with the common-mode filter stage being connected to the at least one primary connection and the differential-mode filter stage being connected to the at least one secondary connection. In this case, at least one first external connection or at least one first external conductor is designed or referred to as an outer conductor. At least one second external connection or at least one second external conductor is designed or referred to as a neutral conductor.

The EMC filter device has at least two internal electrical connections arranged parallel to one another, each having at least one electrical conductor, which are designed to connect the external connections or their conductors, both of which are arranged parallel to one another. In this case, at least one first internal connection or at least one first internal conductor is designed or referred to as an outer conductor. At least one second internal connection or at least one second internal conductor is designed or referred to as a neutral conductor.

In this case, the internal connections, usually two, connected in parallel in the EMC filter device are connected to one another via at least one Class X capacitance as an electrical filter component. Alternatively or additionally, at least one, usually every, internal connection is connected to the housing of the EMC filter device via a Class Y capacitance as an electrical filter component. Furthermore, alternatively or additionally, at least one inductance, e.g., a self-inductance, is associated with at least one internal connection as an electrical filter component, with an individual inductance being associated with at least one internal connection at one point along the connections in each case and a common inductance being associated with a plurality of internal connections at another point.

At least one electrical filter component described above in each case is or will be arranged at at least one point along the internal connections and associated there with the at least one internal connection. Furthermore, it is possible for the at least one electrical filter component to be arranged within at least one of the two described stages and associated there with the at least one internal connection.

Furthermore, the at least one secondary external connection between the EMC filter device and the battery is unshielded or not shielded. Accordingly, in a configuration, among all external connections, only the at least one primary connection has a shield.

The system is intended for a, at least initially, unshielded on-board electrical system, which has the connections for connecting the components, i.e., the inverter and the battery, e.g., an HV or high-voltage battery. In this case, it is possible for the on-board electrical system to also be designed as a high-voltage on-board electrical system of the vehicle and, in addition to the HV or high-voltage battery, to have corresponding high-voltage components, wherein the high-voltage on-board electrical system is also connected to the low-voltage components of the vehicle, possibly in another low-voltage on-board electrical system.

It is possible that the EMC filter device and the at least one shielded primary connection are and/or will be integrated into such an on-board electrical system, wherein it is possible that an already existing connection, which has not yet been shielded, is supplemented by a shield and, thus, is and/or will be designed as the at least one primary connection.

The system is designed for a shielded inverter in an unshielded on-board electrical system, in which only the primary connections and the EMC filter device are otherwise shielded. The shielded inverter, e.g., a pulse-width modulated inverter (PWM inverter), can also be designed and/or referred to as a shielded inverter and/or converter in an unshielded on-board electrical system. It can also be designed as an electrical converter, e.g., a DC/AC converter or AC/DC converter.

The method according to the disclosure is designed to provide an on-board electrical system of a vehicle or for a vehicle having a system, for example an embodiment of the presented system. The on-board electrical system has an inverter and a battery as components, which are to be or are connected to one another within the on-board electrical system, to the on-board electrical system and/or as components of the on-board electrical system. The system for the on-board electrical system has at least one primary shielded external electrical connection, optionally at least one secondary external electrical connection, and an EMC filter device as a component. In this case, the EMC filter device is connected, on the one hand, to the inverter via the at least one primary, usually electromagnetic, shielded external connection and, on the other hand, to the battery via at least one primary external connection.

The EMC filter device or EMC filter box is additionally integrated into the on-board electrical system between the inverter and the battery, wherein the EMC filter device is to be used or will be used to attenuate electromagnetic field and/or wave emissions from the inverter, wherein stricter EMC requirements must be complied with due to the unshielded on-board electrical system.

The method can be used to supplement an existing on-board electrical system, which has the battery and inverter as HV or high-voltage components. This allows cross-platform reuse of the existing on-board electrical system without the need to adapt the already existing components or parts designed or intended in a configuration for high-voltage or HV operation. Furthermore, the on-board electrical system to be provided can be flexibly designed together with the EMC filter device with regard to an installation space in the vehicle.

Usually, the at least one primary shielded external connection is routed from a connection point of the inverter to the EMC filter device or a primary connection point of the EMC filter device, with the at least one primary shielded external connection being connected to the two connection points and arranged between the two components. In this case, the EMC filter device is arranged and/or connected between the inverter and the battery. The EMC filter device must be embodied or designed to be EMC-tight. In addition, the shielding of the at least one primary shielded external connection is placed on the housing of the EMC device, with the housing being enclosed by the shield, which is extended from the one primary shielded external connection to the EMC filter device. The at least one secondary external connection, which is arranged between a secondary connection point of the EMC filter device and a connection point of the battery, can be unshielded. The EMC filter device has a two-stage design, having a common-mode filter stage for common mode and a differential-mode filter stage for differential mode. A configuration of each filter stage from electrical filter components depends on the electromagnetic interferences to be attenuated. In this case, for each filter stage, a specific configuration comprising Class Y capacitances, Class X capacitances, and inductances as electrical filter components is provided.

The inverter, e.g., pulse-width modulated inverter, or referred to in short PWM inverter, is designed in a configuration according to EMC requirements of an HV or high-voltage on-board electrical system. Furthermore, the EMC filter device is designed according to the properties of the high-voltage electrical system. The on-board electrical system includes high-voltage connections and, in addition to the high-voltage battery, other connected parts, an electric air conditioning compressor or a charger. For the usually unshielded high-voltage on-board electrical system, the system presented here complies with electromagnetic compatibility requirements, for example, with regard to interference emissions. Since the EMC filter device will be or is arranged outside the inverter, there is no need to implement electromagnetic compatibility measures in the inverter, meaning that it does not need to be modified.

It shall be understood that the features mentioned above and those to be explained below can be used not only in the combination specified in each case, but also in other combinations or on their own, without departing from the scope of the present disclosure.

### BRIEF DESCRIPTION OF THE SEVERAL VIEWS OF THE DRAWINGS

The disclosure is illustrated schematically in the drawings using embodiments and is described schematically and in detail with reference to the drawings. In the drawings:

FIG. 1a shows a schematic representation of an embodiment of the system according to the disclosure.

FIG. 1b shows a schematic representation of a detail from FIG. 1a.

### DETAILED DESCRIPTION

The figures are described coherently and comprehensively. The same reference numerals are assigned to the same components.

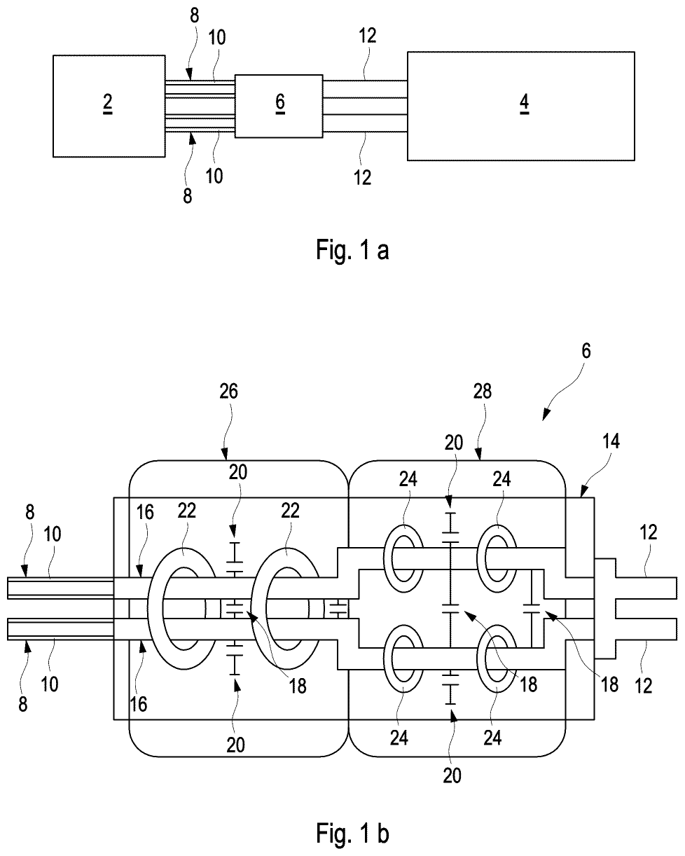

The embodiment of the system according to the disclosure shown schematically in FIG. 1a is intended for an on-board electrical system of a vehicle, usually a motor vehicle, wherein the on-board electrical system has an inverter 2, for example a pulse-width modulated inverter, and a battery 4 as an electrical energy source.

The system presented comprises an EMC filter device 6 or a filter device 6 for electromagnetic compatibility (EMC), which here is arranged and/or electrically interposed between inverter 2 and battery 4. EMC filter device 6 can also be designed or referred to as an EMC filter box. In this case, EMC filter device 6 is connected, on the one hand, to inverter 2 via two primary external electrical connections 8 and, on the other hand, to battery 4 via two further secondary external electrical connections 12, wherein each external connection 8, 12, depending on the configuration of the on-board electrical system, has at least one electrical conductor, i.e., only one conductor or a plurality of conductors.

In this case, for each external connection 8 between inverter 2 and EMC filter device 6, a shield 10, usually electromagnetic, is provided, which encloses the at least one conductor of respective connection 8 and shields it from or against electromagnetic fields from the outside.

In contrast, a shield is omitted for additional external connections 12 between EMC filter device 6 and battery 4, wherein these connections 12 are unshielded or not shielded and continue to be exposed to external electromagnetic fields.

EMC filter device 6 arranged and/or connected between connections 8, 12 comprises a housing 14. Two internal electrical connections 16 are arranged therein, which connect external connections 8, 12 outside housing 14 and have at least one electrical conductor in each case. In this case, EMC filter device 6 has a primary connection point that connects internal connections 16 to primary external connections 8 and inverter 2, and a secondary connection point that connects internal connections 16 to secondary external connections 12 and battery 4. The primary connection point can be designed or referred to as the input and the secondary connection point as the output of EMC filter device 6.

In a configuration, at least one first connection 8, 12, 16 of the respective external or internal connections 8, 12, 16 is designed and/or referred to as an outer conductor. Furthermore, in a configuration, at least one second connection 8, 12, 16 of the respective external or internal connections 8, 12, 16 is designed and/or referred to as a neutral conductor.

In this case, it is provided that EMC filter device 6 is divided into a common-mode filter stage 26 and a differential-mode filter stage 28, wherein common-mode filter stage 26 is arranged downstream of the primary connection point of EMC filter device 6. Differential-mode filter stage 28 is arranged downstream of common-mode filter stage 26 and upstream of the secondary connection point of EMC filter device 6. Common-mode filter stage 26 is designed to filter common-mode electromagnetic radiation and/or to filter common-mode electromagnetic interference and/or to filter common-mode currents flowing through internal connections 16 and can also be designed and/or referred to as a common-mode filter stage. The differential-mode filter stage 28 is designed to filter differential-mode electromagnetic radiation and/or to filter differential-mode electromagnetic interference and/or to filter differential-mode currents flowing through internal connections 16 and can also be designed and/or referred to as a differential-mode filter stage.

Common-mode filter stage 26 is designed to suppress interferences that occur simultaneously on both internal connections 16, here, for example, on the outer conductor and on the neutral conductor, and are referred to as common-mode interferences. In this case, electrical filter components can minimize corresponding unwanted electromagnetic signals and thus improve electromagnetic compatibility (EMC). Differential-mode filter stage 28 is designed to reduce interferences that differ between the outer conductor and the neutral conductor as internal connections 16. This type of interferences is referred to as differential-mode interference. By using electrical filter components in differential-mode filter stage 28, unwanted electromagnetic signals can be effectively filtered out.

In EMC filter device 6, a plurality of Class X capacitances 18 or Class X capacitors are connected between the two internal connections 16 as electrical filter components, which are designed to suppress differential-mode electromagnetic radiation, to suppress differential-mode electromagnetic interference, and/or to suppress differential-mode currents. Furthermore, a plurality of Class Y capacitances 20 or Class Y capacitors are connected between each internal connection 16 and housing 14 as electrical filter components, which are designed to suppress common-mode electromagnetic radiation, to suppress common-mode electromagnetic interference, and/or to suppress common-mode currents. In addition, at least one inductance or inductor 22, 24 is assigned to at least one internal connection 16 in each case.

In detail, within common-mode filter stage 26, starting from the primary connection point, a first common inductance 22 is associated with both internal connections 16 at a first point along connections 16 as an electrical filter component. Downstream of this, internal connections 16 are connected to one another at a second point via a first Class X capacitance 18. Furthermore, each internal connection 16 is individually connected to housing 14 as a reference point or ground via a first Class Y capacitance 20. Downstream of this, a second common inductance 22 is associated with both internal connections 16 at a third point as an electrical filter component. Downstream of this, internal connections 16 are connected to one another at a fourth point along connections 16 via a second Class X capacitance 18.

Downstream of this, within differential-mode filter stage 28 downstream of common-mode filter stage 26 at a fifth point along connections 16, a first individual inductance 24 is associated with each internal connection 16 as an electrical filter component. Downstream of this, internal connections 16 are connected to one another at a sixth point via a third Class X capacitance 18; moreover, each internal connection 16 is individually connected to housing 14 as a reference point or ground via a second Class Y capacitance 20. Downstream of this, at a seventh point, a second individual inductance 24 is associated with each internal connection 16 as an electrical filter component. Downstream of this, internal connections 16 are connected to one another at an eighth point along connections 16 via a fourth Class X capacitance 18.

Class X capacitances 18 or Class X capacitors and Class Y capacitances 20 or Class Y capacitors used here can be designed or referred to as interference suppression capacitors, radio interference suppression capacitors or safety capacitors and are designed for radio interference suppression and/or reducing electromagnetic interference (EMC) caused by the operation of electrical and/or electronic devices.

One Class X capacitance 18 or one Class X capacitor in each case is connected between two internal connections 16 or internal conductors, e.g., between an outer conductor and a neutral conductor or between two outer conductors. One Class Y capacitance 20 or one Class Y capacitor in each case is connected between one internal connection 16 or an internal conductor, i.e., either between an outer conductor or a neutral conductor, on the one hand, and the accessible, protectively grounded housing 14 on the other.

In each case, a common inductance 22 of common-mode filter stage 26, which can also be referred to as a common-mode inductance, is designed to suppress conductor-bound interferences or common-mode interferences that can occur simultaneously on two internal connections 16 or conductors shown here, e.g., an outer conductor and a neutral conductor, or both outer conductors. Common inductance 22 for internal connections 16 smooths a current profile and reduces harmonics. This minimizes unwanted signals and improves electromagnetic compatibility (EMC), allowing compliance with standards for electromagnetic emissions and electromagnetic immunity.

Each individual inductance 24 of the differential-mode filter stage 28 can also be referred to as a differential-mode inductance. It is designed to reduce different electromagnetic interferences between two internal connections 16 or conductors shown here, e.g., an outer conductor and a neutral conductor or both outer conductors. Individual inductance 24 bridges a basic insulation of a respective internal connection 16 and serves a safety purpose. Each individual inductance 24 is designed to filter differential-mode interferences, effectively filtering out unwanted electromagnetic signals. Individual inductance 24 is connected in each case between an internal connection, i.e., either the outer conductor or the neutral conductor on the one hand, and the accessible, protectively grounded housing 14 on the other. Individual inductances 24 are designed for EMC filtering and ensure electromagnetic compatibility.

Both types of inductances used here, i.e., both common inductances 22 and individual inductances 24, are designed to minimize electromagnetic interferences and to comply with electromagnetic compatibility (EMC) requirements.

Furthermore, an electromagnetic shield is also provided for EMC filter device 6, which is designed here as an extension of at least one shield 10, i.e., only one shield 10 or a plurality of shields 10, of external connections 8 between inverter 2 and EMC filter device 6, wherein the at least one shield 10 extends onto housing 14 and/or encloses it and thereby shields it against electromagnetic radiation.

German patent application no. 102024115753.4, filed Jun. 6, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A system for an on-board electrical system of a vehicle, wherein the on-board electrical system has an inverter and a battery, the system comprising:
at least one primary shielded external electrical connection; and
an electromagnetic compatibility (EMC) filter device,
wherein the EMC filter device is connected to the inverter via the at least one primary shielded external electrical connection, and
wherein the EMC filter device is connected to the battery via at least one secondary external electrical connection.

2. The system according to claim 1, wherein the EMC filter device has an electromagnetic shield.

3. The system according to claim 1, wherein a shield of the at least one primary shielded external electrical connection between the inverter and the EMC filter device extends to the EMC filter device.

4. The system according to claim 1, wherein the EMC filter device has a common-mode filter stage and a differential-mode filter stage.

5. The system according to claim 1, wherein the EMC filter device has at least two internal connections arranged parallel to one another,
wherein the at least two internal connections connect the at least one primary shielded external electrical connection and the at least one secondary external electrical connections,
wherein the internal connections are connected to one another via at least one Class X capacitor, and/or
wherein at least one internal connection is connected to a housing of the EMC filter device via a Class Y capacitor, and/or
wherein at least one inductor is associated with the at least one internal connection.

6. The system according to claim 1, wherein the at least one secondary external electrical connection between the EMC filter device and the battery is unshielded.

7. The system according to claim 1, wherein the on-board electrical system is unshielded.

8. The system according to claim 1, wherein the inverter is shielded.

9. A method for providing an on-board electrical system for a vehicle having a system, wherein the on-board electrical system has an inverter and a battery, the method comprising:
providing at least one primary shielded external electrical connection;
providing an electromagnetic compatibility (EMC) filter device;
connecting the EMC filter device to the inverter via the at least one primary shielded external electrical connection; and
connecting the EMC filter device to the battery via at least one secondary external electrical connection.
